(19) United States
(12) Patent Application Publication
(10) Pub. No.: US 2010/0102954 A1
(43) Pub. Date: Apr. 29, 2010

(54) Automatic Personal Warning Alert

(76) Inventors: Zoran Radivojevic, Cambridge (GB); Kimmo Kalliola, Helsinki (FI)

Correspondence Address: HARRINGTON & SMITH, 4 RESEARCH DRIVE, Suite 202, SHELTON, CT, 06484-6212, US

(21) Appl. No.: 12/595,264

(22) PCT Filed: Apr. 11, 2007
(86) PCT No.: PCT/IB2007/002343

§ 371 Date: Dec. 1, 2009

(51) Int. Cl. G08B 1/08

(52) U.S. Cl. 340/539.11

(57) ABSTRACT

An automatic personal warning system including: a first moving radio frequency transmitter apparatus; a first movable radio frequency receiver apparatus configured to receive first radio frequency signals originating from the first moving radio frequency transmitter apparatus and thereby obtain an indication of a kinematic parameter of the first moving radio frequency transmitter apparatus and configured to automatically generate a personal warning alert to a user of the first movable radio frequency receiver apparatus if the kinematic parameter of the first moving radio frequency transmitter apparatus satisfies a defined criterion.

### FIELD OF THE INVENTION

Embodiments of the present invention relate to automatic personal warning alert generation. In particular, they relate to systems, apparatuses, methods and computer program products for automatically generating a personal warning alert.

### BACKGROUND TO THE INVENTION

It is now common for persons to carry with them electronic apparatus. It would be desirable to use existing electronic apparatuses or to provide new electronic apparatuses that automatically provide a warning alert to a user.

### BRIEF DESCRIPTION OF VARIOUS EMBODIMENTS OF THE INVENTION

According to various embodiments of the invention there is provided an automatic personal warning system comprising: a first moving radio frequency transmitter apparatus; a first movable radio frequency receiver apparatus configured to receive first radio frequency signals originating from the first moving radio frequency transmitter apparatus and thereby obtain an indication of a kinematic parameter of the first moving radio frequency transmitter apparatus and configured to automatically generate a personal warning alert to a user of the first movable radio frequency receiver apparatus if the kinematic parameter of the first moving radio frequency transmitter apparatus satisfies a defined criterion.

According to various embodiments of the invention there is provided an apparatus comprising: an alert device; a memory storing a defined criterion; receiver circuitry for receiving first radio frequency signals originating from a first moving radio frequency transmitter apparatus; processing circuitry configured to obtain, from the received first radio frequency signal, an indication of a kinematic parameter of the first moving radio frequency transmitter apparatus and configured to automatically control the alert device to generate a personal warning if the obtained kinematic parameter satisfies the defined criterion.

According to various embodiments of the invention there is provided an apparatus comprising: alert means; memory means for storing a defined criterion; receiver means for receiving first radio frequency signals originating from a first moving radio frequency transmitter apparatus; processing means for obtaining, from the received first radio frequency signal, an indication of a kinematic parameter of the first moving radio frequency transmitter apparatus and for automatically controlling the alert device to generate a personal warning if the obtained kinematic parameter satisfies the defined criterion.

According to various embodiments of the invention there is provided a method comprising: receiving first radio frequency signals originating from a first moving radio frequency transmitter apparatus; obtaining, from the received first radio frequency signal, an indication of a kinematic parameter of the first moving radio frequency transmitter apparatus; and automatically generating a personal warning alert if the obtained kinematic parameter satisfies a defined criterion.

According to various embodiments of the invention there is provided a computer program product comprising computer readable instructions which enable a computer to: obtain, from a received signal, an indication of a kinematic parameter of a moving radio frequency transmitter apparatus; and to automatically enable generation of a personal warning alert if the obtained kinematic parameter satisfies a defined criterion.

Various embodiments of the invention therefore provide for automatic generation of a personal alert for a user when there is apparent danger from an approaching vehicle carrying a transmitter apparatus.

### BRIEF DESCRIPTION OF THE DRAWINGS

For a better understanding of various embodiments of the present invention reference will now be made by way of example only to the accompanying drawings in which:

FIG. 1 schematically illustrates an embodiment of an automatic personal warning system;

FIG. 2 schematically illustrates an embodiment of an automatic personal warning system;

FIG. 3 schematically illustrates an embodiment of a moving radio frequency transmitter apparatus;

FIG. 4 schematically illustrates an embodiment of a movable radio frequency receiver apparatus;

FIG. 5 schematically illustrates an embodiment of one type of movable radio frequency receiver apparatus that has multiple receivers;

FIG. 6 schematically illustrates an embodiment of a method for automatically generating a personal warning alert; and

FIG. 7 schematically illustrates an embodiment of one method for determining a kinematic parameter.

### DETAILED DESCRIPTION OF VARIOUS EMBODIMENTS OF THE INVENTION

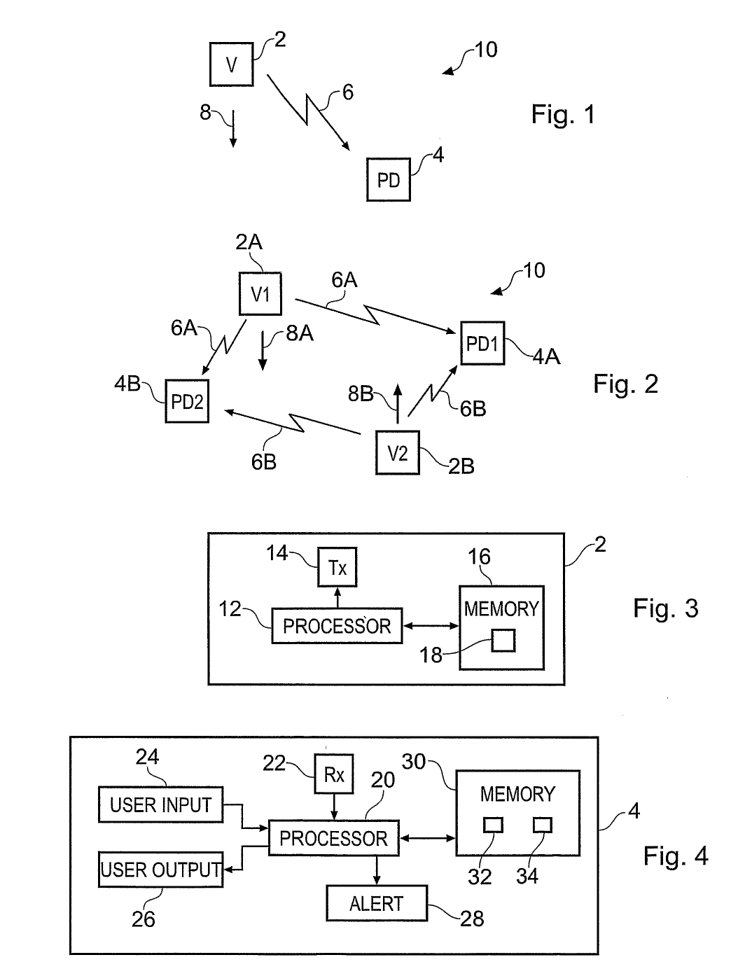

FIG. 1 schematically illustrates an automatic personal warning system 10 comprising: a first moving radio frequency (RF) transmitter apparatus 2; and a first movable radio frequency (RF) receiver apparatus 4.

A ‘receiver apparatus’ is an apparatus that is configured to receive RF signals. It may be a dedicated receiver without any transmitter functionality or it may have transmitter functionality. The transmitter functionality may be provided using transmitter circuitry that is separate to receiver circuitry or may be provided by a transceiver that integrates transmitter and receiver circuitry.

A ‘transmitter apparatus’ is an apparatus that is configured to transmit RF signals. It may be a dedicated transmitter without any receiver functionality or it may have receiver functionality. The receiver functionality may be provided using receiver circuitry that is separate to transmitter circuitry or may be provided by a transceiver that integrates transmitter and receiver circuitry.

The transmitter apparatus 2 transmits a RF signal 6, which is received by the receiver apparatus 4. The RF signal may be a signal that is specifically addressed to the receiver apparatus 4 or may be a broadcast signal. The RF signal is received, in the illustrated example, directly at the receiver apparatus 4 without passing through an intervening network element or relay.

The transmitter apparatus 2 is moving with a velocity 8 and the receiver apparatus uses the received RF signal 6 to obtain (receive and/or determine) a kinematic parameter related to the velocity 8.

The kinematic parameter may be, for example, a time varying position or relative displacement, speed, a velocity component, a velocity vector, acceleration etc.

The kinematic parameter may be a translational kinematic parameter defining relative translational motion between the receiver apparatus 4 and the transmitter apparatus 2.

The translational kinematic parameter may indicate speed. It may for example indicate a radial velocity component relative to the receiver apparatus 4 i.e. speed towards/away from the receiver apparatus. It may, alternatively indicate velocity.

The obtained kinematic parameter is used to generate automatically a warning alert when the kinematic parameter satisfies a defined criterion. For example, if the kinematic parameter indicates that the transmitter apparatus 2 is approaching ‘too’ fast.

The kinematic parameter is used to generate a warning alert that is personal to a user of the receiver apparatus 4 and the kinematic parameter is not permanently stored for future use. The system 10 provides a personal warning system where ‘personal’ indicates private to a member of the public rather than for use by a public authority.

A schematic illustration of one possible embodiment of the transmitter apparatus 2 is presented in FIG. 3.

The transmitter apparatus 2 comprises processing circuitry 12, transmitter circuitry 14 which may or may not be part of a transceiver, and a memory 16 storing a computer program 18.

The transmitter circuitry 14 may be configured for direct RF communication with a receiver apparatus 4 without the use of intervening network elements. The direct RF communication may be provided by a communication technology that has a range, for example, of the order 100 m. The direct RF communication may be provided using WIBREE (trademark) or WiFi technology.

The computer program 18 comprises computer readable instructions that control the operation of the transmitter apparatus 2 when loaded into the processor 12. In a ‘transmitter active’ embodiments, the transmitter apparatus 2 determines the kinematic parameter and encodes it within the transmitted RF signals 6. The receiver apparatus obtains the kinematic parameter by decoding the received RF signals 8 to recover the transmitted kinematic parameter. In a ‘transmitter passive’ embodiments, the transmitter does not send the kinematic parameter but the receiver apparatus 4 determines the kinematic parameter. In the ‘transmitter passive’ embodiments, the transmitter apparatus may send a predetermined signal that assists the receiver apparatus 4 such as a training sequence.

The computer program instructions may arrive at the transmitter apparatus 2 via an electromagnetic carrier signal or be copied from a physical entity such as a computer program product, a memory device or a record medium such as a CD-ROM or DVD.

The transmitter apparatus 2 may be integrated into another apparatus such as a vehicle (e.g. car, tram, train, lorry etc). In this implementation, the automatic personal warning system 10 creates a personal warning to the user of the receiver apparatus 4 when the vehicle carrying the transmitter apparatus 2 poses a potential danger to that user. The transmitter apparatus 2 in this implementation may be provided as a stand alone apparatus or as a module. A module transmitter apparatus provides some, but not all of the components of the transmitter apparatus 2 and the remaining components are provided by the module host e.g. the vehicle it is integrated with.

A schematic illustration of one possible embodiment of the receiver apparatus 4 is presented in FIG. 4.

The receiver apparatus 4 may comprise: processing circuitry 20; receiver circuitry which may or may not be part of a transceiver; a user input interface 24 such as a keypad, joystick etc; a user output interface 26 such as a display, loudspeaker, vibra, piezoelectric vibrating surface or a set of piezoelectric surfaces for threat arrival directional information, etc; an alert device 28; and a memory 30 storing a data structure 32 specifying the criterion and a computer program 34.

The alert device 28 may be any suitable device that attracts the attention of a user of the receiver apparatus 4. It may, for example, use a vibration alert to attract the user's attention via touch and/or it may use an audio output device to attract the user's attention via hearing and/or it may use a visual output device to attract the user's attention via sight (suggesting a threat and/or direction of the threat arrival). Although the alert device 28 is illustrated as a separate component for clarity, it may be integrated within the user output interface and some or all of the user output interface 26 may be used for the warning alert 28.

The receiver circuitry 22 may be configured for direct RF communication with a transmitter apparatus 2 without the use of intervening network elements.

The direct RF communication may be provided by a communication technology that has a range, for example, of the order 100 m. The direct RF communication may be provided using WIBREE (trademark) or WiFi technology.

The computer program 34 comprises computer readable instructions that control the operation of the receiver apparatus 2 when loaded into the processor 20.

In the ‘transmitter active’ embodiments, the processing circuitry 20 obtains the kinematic parameter by decoding the received RF signals 8 to recover the transmitted kinematic parameter. In the ‘transmitter passive’ embodiments, the processing circuitry 20 determines the kinematic parameter as described in more detail below.

The computer program instructions may arrive at the transmitter apparatus 2 via an electromagnetic carrier signal or be copied from a physical entity such as a computer program product, a memory device or a record medium such as a CD-ROM or DVD.

The data structure 32 defining the criterion may in some implementations be read-only. The data structure 32 defining the criterion may in other implementations be updatable. For example, a user may use the user input interface to program a new criterion updating the data structure 32. The computer program 34 may provide an interface that assists in adaptation of the criterion.

A ‘criterion’ may be a logical function. A logical function may have a single argument such as the kinematic parameter and in this case satisfaction of the criterion depends solely upon the value of the kinematic parameter. The criterion provides for automatic generation of the warning alert when the first moving transmitter apparatus is a threat because, for example, it is approaching the user too fast.

A logical function may have multiple arguments at least one of which is a kinematic parameter. In this case satisfaction of the criterion depends upon the values of the arguments. A kinematic parameter satisfies this type of criterion, when it (and the other arguments) satisfy the logical function. Another argument may, for example, be relative displacement. The criterion provides for automatic generation of warning alert when the first moving transmitter apparatus is a threat because, for example, it is approaching too fast and/or is too close to the user.

The transmitter apparatus 2 may be integrated into another apparatus such as a personal electronic device. A personal electronic device is a device that is typically used by a single user. It may be sized for carrying on or about the person. It could for example be a mobile cellular telephone, a personal digital assistant, a personal media player etc. The receiver apparatus 4 in this implementation may be provided as a stand alone apparatus or as a module.

A module receiver apparatus provides some, but not all of the components of the receiver apparatus 4 and the remaining components are provided by the module host e.g. the personal electronic device it is integrated with.

FIG. 6 schematically illustrates a method 40 for automatically generating a personal warning alert at a receiver apparatus 4.

The receiver circuitry 22 is configured to tune to the radio frequency of the transmitted signals 6 and receive, at block 42, the RF signals 6 originating from the moving transmitter apparatus 2.

The processing circuitry 20 is configured to obtain, at block 44, an indication of a kinematic parameter of the moving transmitter apparatus 2

The processing circuitry 20 is configured to determine, at block 44, when the kinematic parameter of the transmitter apparatus 2 satisfies the criterion defined by the stored data structure 34.

The processing circuitry 20 is configured to automatically generate, at block 46, a personal warning alert to a user of the receiver apparatus 4 if the criterion was satisfied at block 44.

FIG. 7 schematically illustrates one ‘passive transmitter’ method 50 in which the receiver apparatus 4 determines the kinematic parameter using rate of change of relative displacement.

The receiver apparatus 4 comprises power level detector circuitry, within the receiver circuitry 22. At bock 52, the detector circuitry detects a power level of the received signal 6.

The processing circuitry 20 is configured to convert, at block 54, a measured power level to a value for the relative displacement between the receiver apparatus 4 and the transmitter apparatus 2. The processing circuitry 20 may use a formula or look-up table to convert receiver signal power levels to values of relative displacement.

The processing circuitry 20 is configured to convert, at block 56, a sequential series of relative displacements to a kinematic parameter—a radial component of relative velocity. The processing circuitry 20 determines the differential of the relative displacement.

Alternatively or additionally, the processing circuitry 20 may be configured to convert, at block 54, a sequential series of received signal power levels to values of absolute displacement between the receiver apparatus 4 and the transmitter apparatus 2.

The criterion defined by the data structure 34 may be satisfied when the radial velocity component exceeds a defined value. The value may be user programmable.

The criterion defined by the data structure 34 may have as arguments the radial component of the velocity and the detected power level (or relative displacement). The criterion may be satisfied when the radial velocity component and the power level/relative displacement have certain value pairings. The pairing of values that satisfy the criterion may be programmed by a user.

For example, the power level/relative displacement may give a proximity value p that indicates how close the transmitter is and a value v indicting how fast it is moving. The criterion could, as an example, be v/p>X where X is a user defined value. The function v/p has the property that it increases as p decreases and as v increases and other functions with similar properties may be used. Several functions based on different threat models can be offered to a user that he/she can select the most suitable one in accordance with the usage conditions.

The receiver apparatus 4 may determines the kinematic parameter using Doppler shift detection. The RF of the transmitted signal 6 (as received by the receiver apparatus 4) is phase shifted in proportion to the relative speed of the transmitter apparatus 2 and the receiver apparatus 4.

The receiver circuitry 22 may comprise an accurate frequency reference that enables a Doppler shift of a received signal to be quantified. Once quantified, the shift may be converted by the processing circuitry 20 to a kinematic parameter- the radial component of the relative velocity between the transmitter apparatus 2 and the receiver apparatus 4.

The criterion may be as described with reference to FIG. 7. A mechanism for determining relative displacement between the transmitter apparatus 2 and the receiver apparatus 4 may also be provided.

The receiver apparatus 4 may determine the kinematic parameter using time-of arrival or phase information.

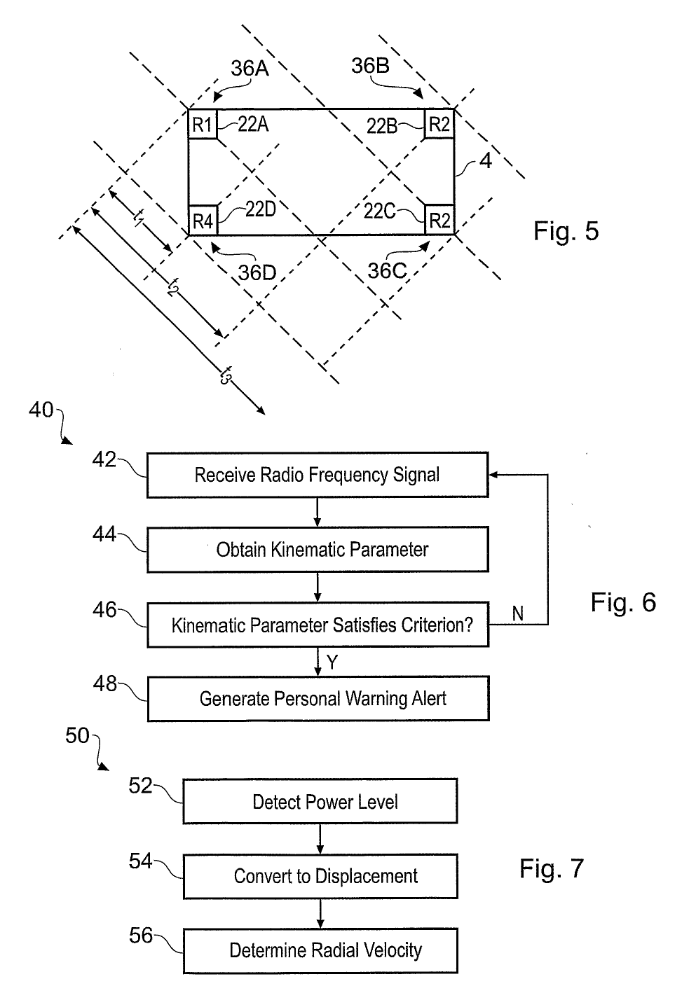

This method relies upon reception of the same transmitted signal 6 at different locations. The different locations may be locations within the receiver apparatus 4 as illustrated in FIG. 5.

The illustrated receiver apparatus 4 that has multiple receivers 22A, 22B, 22C and 22D located at respective different non-collinear positions 36A, 36B, 36C and 36D within a housing of the receiver apparatus 4. The different receivers 22A, 22B, 22C, 22D may be separate receiver circuitries or separate elements of a receiver antenna.

The processing circuitry 20 is configured to determine, as the kinematic parameter, relative direction of the transmitter apparatus 2 using information recording the time of arrival of the same signal 6 originating from the transmitter apparatus 2 at the physically separated receivers 36A-36D. The processing circuitry 20 is also configured to determine the angular velocity of the transmitting apparatus 2 based on calculating the differential of the relative direction measurements.

The automatic personal warning system 10 illustrated in FIG. 1, may be extended by having additional transmitter apparatuses. Each of the transmitter apparatuses 2 transmits signals that enable the receiver apparatus 4 to determine kinematic parameters for each of the transmitter apparatuses. The kinematic parameter and the methods of obtaining the kinematic parameter may be the same or different for the transmitter apparatuses. The receiver apparatus 4 automatically generates an alert if any one of the kinematic parameters for the respective transmitter apparatuses satisfies the defined criterion. The receiver apparatus is able to track in real-time the kinematic parameters of all of many transmitter apparatuses. Ranking of the threat and danger may be provided by the function defining the criterion. This enables prioritization of the most dangerous moving objects (transmitter apparatuses) which are then tracked in real-time. Real-time tracking of some but not all of the moving transmitter apparatuses reduces processing load and intelligent selection of the moving transmitter apparatuses for real-time tracking based on apparent level of threat should result in a reduced processing load without compromising operability. The most dangerous one(s) may be the closest and/or the fastest and/or the one approaching for direct collision etc. The number of simultaneously tracked moving transmitter apparatuses can be set by the system automatically or by the user accordingly to the memory availability and usage conditions. The tracking information may be displayed in a display of the user output interface 26.

The automatic personal warning system 10 illustrated in FIG. 1, may be extended by having one or more an additional receiver apparatuses 4. The additional receiver apparatuses are used to provide warning alerts to their respective users as described above.

FIG. 2 schematically illustrates an automatic personal warning system 10 comprising: a first moving radio frequency transmitter apparatus 2A; a second moving radio frequency transmitter apparatus 2B; a first movable radio frequency receiver apparatus 4A; a second movable radio frequency receiver apparatus 4B.

The first transmitter apparatus 2A s moving with a velocity 8A and broadcasts a signal 6A for reception by the receiver apparatuses.

The second transmitter apparatus 2B is moving with a velocity 8B and broadcasts a signal 6B for reception by the receiver apparatuses.

In the first receiver apparatus 4A, the receiver circuitry 22 is configured to receive first radio frequency signals 6A originating from a first moving radio frequency transmitter apparatus 2A and the processing circuitry 20 is configured to obtain, from the received first radio frequency signal 6A, an indication of a kinematic parameter of the first moving radio frequency transmitter apparatus 2A and is configured to automatically control the alert device 28 to generate a personal warning if the obtained kinematic parameter satisfies a defined criterion. The receiver circuitry 22 is additionally configured to receive second radio frequency signals 6B originating from a second moving radio frequency transmitter apparatus 2B and the processing circuitry 20 is additionally configured to obtain, from the received second radio frequency signal 6B, an indication of a kinematic parameter of the second moving radio frequency transmitter apparatus 2B and is configured to automatically control the alert device 28 to generate a personal warning if the obtained kinematic parameter satisfies a defined criterion.

In the second receiver apparatus 4B, the receiver circuitry 22 is configured to receive first radio frequency signals 6A originating from a first moving radio frequency transmitter apparatus 2A and the processing circuitry 20 is additionally configured to obtain, from the received first radio frequency signal 6A, an indication of a kinematic parameter of the first moving radio frequency transmitter apparatus 2A and is configured to automatically control the alert device 28 to generate a personal warning if the obtained kinematic parameter satisfies a defined criterion. The receiver circuitry 22 is additionally configured to receive second radio frequency signals 6B originating from a second moving radio frequency transmitter apparatus 2B and the processing circuitry 20 is additionally configured to obtain, from the received second radio frequency signal 6B, an indication of a kinematic parameter of the second moving radio frequency transmitter apparatus 2B and is configured to automatically control the alert device 28 to generate a personal warning if the obtained kinematic parameter satisfies a defined criterion.

The blocks illustrated in the FIGS. 6 and 7 may represent steps in a method and/or sections of code in the computer program 32. The illustration of a particular order to the blocks does not necessarily imply that there is a required or preferred order for the blocks and the order and arrangement of the block may be varied.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An automatic personal warning system comprising:
a first moving radio frequency transmitter apparatus; a first movable radio frequency receiver apparatus configured to receive first radio frequency signals originating from the first moving radio frequency transmitter apparatus and thereby configured to obtain an indication of a kinematic parameter of the first moving radio frequency transmitter apparatus and configured to automatically generate a personal warning alert to a user of the first movable radio frequency receiver apparatus if the kinematic parameter of the first moving radio frequency transmitter apparatus satisfies a defined criterion.

2. (canceled)

3. A system as claimed in claim 1, wherein the criterion provides for automatic generation of the warning alert when the first moving transmitter apparatus is a threat because it is approaching the user too fast and/or it is approaching too close to the user.

4. A system as claimed in claim 1, wherein the first movable radio receiver is integrated within a personal electronic device sized for carrying on or about the person.

5. A system as claimed in claim 1, wherein the first moving radio transmitter apparatus is integrated within a vehicle.

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A system as claimed in claim 1, wherein the first moving radio frequency transmitter apparatus and the first movable radio frequency receiver apparatus are configured for direct radio frequency communication without an intervening network.

19. (canceled)

20. (canceled)

21. (canceled)

22. (canceled)

23. An apparatus comprising:
an alert device;
a memory storing a defined criterion;
receiver circuitry configured to receive first radio frequency signals originating from a first moving radio frequency transmitter apparatus;
processing circuitry configured to obtain, from the received first radio frequency signal, an indication of a kinematic parameter of the first moving radio frequency transmitter apparatus and configured to automatically control the alert device to generate a personal warning if the obtained kinematic parameter satisfies the defined criterion.

24. (canceled)

25. An apparatus as claimed in claim 23, wherein the apparatus is movable and the kinematic parameter is a translational kinematic parameter defining relative translational motion between the movable radio receiver apparatus and the first radio frequency transmitter apparatus.

26. (canceled)

27. An apparatus as claimed in claim 23, comprising detector circuitry configured to measure a power level of a received signal, wherein the processing circuitry is configured to convert the measured power levels to a kinematic parameter.

28. An apparatus as claimed in claim 27, wherein the kinematic parameter is radial velocity and the kinematic parameter satisfies the defined criterion when the radial velocity exceeds a defined value.

29. An apparatus as claimed in claim 27, wherein the kinematic parameter is radial velocity and the processing circuitry is configured to determine satisfaction of the defined criterion when the detected power level exceeds a minimum value and the radial velocity exceeds a defined value.

30. (canceled)

31. (canceled)

32. (canceled)

33. An apparatus as claimed in claim 23, wherein the kinematic parameter is velocity and the kinematic parameter satisfies the defined criterion when the probability of a high speed collision between the first moving radio frequency transmitter apparatus and the apparatus exceeds a defined value.

34. An apparatus as claimed in claim 23, wherein the receiver circuitry is configured to receive second radio frequency signals originating from a second moving radio frequency transmitter apparatus and the processing circuitry is additionally configured to obtain, from the received second radio frequency signal, an indication of a kinematic parameter of the second moving radio frequency transmitter apparatus and is configured to automatically control the alert device to generate a personal warning if the obtained kinematic parameter satisfies a defined criterion and wherein the apparatus is configured for real-time tracking of at least both the first moving radio frequency transmitter apparatus and the second moving radio frequency transmitter apparatus.

35. (canceled)

36. (canceled)

37. (canceled)

38. A method comprising:
receiving first radio frequency signals originating from a first moving radio frequency transmitter apparatus;
obtaining, from the received first radio frequency signal, an indication of a kinematic parameter of the first moving radio frequency transmitter apparatus; and
automatically generating a personal warning alert if the obtained kinematic parameter satisfies a defined criterion.

39. A method as claimed in claim 38, wherein the defined criterion is user programmable.

40. A method as claimed in claim 38, comprising receiving the kinematic parameter.

41. A method as claimed in claim 38, comprising determining the kinematic parameter.

42. A method as claimed in claim 38, further comprising determining the kinematic parameter by measuring a rate of change of relative displacement to the first moving radio frequency transmitter apparatus.

43. A method as claimed in claim 38, further comprising determining the kinematic parameter by measuring Doppler shift.

44. A method as claimed in claim 38, further comprising determining the kinematic parameter by using a multi-antenna receiver and processing time of arrival or phase measurements.

45. A method as claimed in claim 44, receiving second radio frequency signals originating from a second moving radio frequency transmitter apparatus; obtaining, from the received second radio frequency signal, an indication of a kinematic parameter of the second moving radio frequency transmitter apparatus; and automatically generating a personal warning alert if the obtained kinematic parameter satisfies a defined criterion.

46. (canceled)

47. (canceled)

48. (canceled)
